(19) United States
(12) Patent Application Publication
(10) Pub. No.: US 2023/0182046 A1
(43) Pub. Date: Jun. 15, 2023

(54) FILTER ARRANGEMENTS

(71) Applicant: NETAFIM, LTD., TEL AVIV (IL)

(72) Inventor: AMIT GILBOA, KIBUTZ SDOT YAM (IL)

(73) Assignee: NETAFIM, LTD., TEL AVIV (IL)

(21) Appl. No.: 18/164,107

(22) Filed: Feb. 3, 2023

Related U.S. Application Data
(63) Continuation-in-part of application No. PCT/IB2021/057026, filed on Aug. 1, 2021.
(60) Provisional application No. 63/060,133, filed on Aug. 3, 2020.

(51) Int. Cl. B01D 29/68; B01D 29/54

(52) U.S. Cl. CPC B01D 29/682; B01D 29/54; B01D 2201/082

(57) ABSTRACT

A filter arrangement includes a cleaning mechanism for cleaning at least one screen filter of the filter arrangement. The cleaning mechanism has a flush chamber, a central hollow core that extends through the flush chamber, and suction nozzles fitted to the core. The core extends between opposing axial ends that are located outside of the flush chamber in exposure to substantially similar pressures at least during a cleaning operation of the cleaning mechanism.

### RELATED APPLICATIONS

This is a Bypass Continuation-in-Part of International Patent Application No. PCT/IB2021/057026 filed Aug. 1, 2021, and published as WO 2022/029590A1. Priority is claimed to U.S. Provisional Patent Application No. 63/060,133 filed Aug. 3, 2020. The aforementioned applications are incorporated by reference in their entirety.

### TECHNICAL FIELD

Embodiments of the invention relate to filter arrangements, in particular of a type comprising screen filter(s) and cleaning mechanism for such screen filter(s).

### BACKGROUND

Common screen filter formations include a filter body, a cylindrical screen element and inlet and outlet ports. Non-filtered water enters through the inlet port at an incoming pressure P. From there the incoming water flows into an inner side of the cylindrical screen element, passing through the screen mesh where most dirt within the water is blocked and kept on the inner side of the cylindrical screen element as so called “filtration cake”. Cleaner water flows onwards towards the outlet port at pressure P out.

Filters that include suction based hydraulic self-cleaning mechanisms, typically include a cleaning mechanism that facilitates cleaning of the screen's inner face by utilizing pressure differences between pressure within the filter and atmospheric pressure or other low-pressure source. Such filters typically have a central cleaning mechanism that includes an inner tube, positioned at the center of cylindrical screen element, with suction nozzles. The nozzle spouts are positioned in proximity to the screen's inner face in order to assist in cleaning the “filtration cake” by suction.

Water being sucked by the nozzles can flow through the inner tube to a flushing chamber that may be connected or disconnected to the ambient environment by opening or closing an internal or external flush valve. As long as the flush valve is closed, the suction process is inactive and thus no filter cleaning occurs. Once the flush valve opens, pressure difference between pressure within the filter and the ambient environment or other lower pressure source urges the cleaning action to start. Pressure differences between filter inlet pressure (P) and atmospheric pressure creates suction forces at the nozzle tips, which accordingly clean the filter's inner side.

In order to clean all the screen's inner face, the nozzles are also urged to move along the screen's inner face while performing their suction process. Such scanning of the filter's inner side is typically performed by combination of circular and linear movements of the suction nozzles. The circular and linear (axial) movements can be performed by usage of a screw that creates axial and circular movements that may be created by a hydraulic turbine, or other rotational movement actuators, such as motors, springs (etc.).

Self-cleaning filters, that scan the filters by combined axial and rotational movement of suction nozzles, may execute such cleaning actions by utilizing coordinated or non-coordinate movement modes, e.g. rotational and axial movements are not necessarily at the same ratio and/or timing.

In the non-coordinate mode, the radial and axial movements may be performed independent from each other. They may be performed in certain cases at the same time but not in coordination one with the other.

In the coordinated mode, the radial and axial movements may be coordinated one with the other. This may be accomplished using a tapered screw that when rotated may generate axial movement at its tapered tip along the screw's central axis. The screw's rotational movement is achieved using internal hydraulic force (hydraulic turbine) or external force (manual rotation of the shaft, motor operated mechanism, etc.).

External operated shaft can use uni-directional screw, since it is simple to control the direction of axial movement—rotation clockwise will result in axial movement in a first axial direction, while rotation counter clockwise will result in axial movement in a second, opposite axial direction.

Internally operated shaft, where the driving force is the flushing water going through the turbine curved channels, and the rotation generating mechanism is internal, and located inside the wet, pressurized chamber, are difficult to operate at a changeable rotation direction mode.

Due to that, most of the screw operated self-cleaning filters, that include an internal rotation turbine, use a bi-directional screw, so the rotational direction does not change, but the axial movement switches at the end of tapper (end of thread) position.

U.S. Pat. No. 6,267,879 for example describes a filtering apparatus where in operation water entering its inlet, passes through a screen into a filtering chamber to then pass through a filtering element before exiting the apparatus via an outlet. A cleaning system of the apparatus includes a connector unit with dirt suctioning members and spraying nozzles for cleaning the filter element. The cleaning system is activated whenever the liquid differential pressure exceeds a predetermined value indicating that the cylindrical filter requires a cleaning treatment.

U.S. Pat. No. 8,028,841 in yet another example describes an apparatus and method that include a filter and cleaning processes for same. A rotating cleaning element is actuated by vacuum pressure, and controls ensure that all portions of the filter's surface are vacuum cleaned during cleaning cycles.

A potential drawback in certain screen filters may be in unbalancing occurring in forces applied upon the two sides of the filter's suction shaft (e.g. during flush). These pressure differences may result in axial forces being applied upon the suction shaft/tube and the suction mechanism in general. These forces may amplify friction, wear, and loads possibly also on other parts at the flush mechanism, and reduce the system efficiency, reliability, robustness, (etc.).

### SUMMARY

The following embodiments and aspects thereof are described and illustrated in conjunction with systems, tools and methods which are meant to be exemplary and illustrative, not limiting in scope.

In at least certain embodiments there is provided a filter arrangement with an external body adapted to hold internal pressures during a filtering operation.

Such filter arrangement may be arranged in at least certain embodiments to include a so-called balanced cleaning system that may employ suction nozzles for cleaning screen filter(s) located within the external body of the filter arrangement.

Such filter arrangement with balanced cleaning system may be obtained by harnessing a generally symmetrical filter configuration, for example a double generally symmetrical filter configuration, for balancing out axial forces imposed upon the system during a cleaning operation.

In certain embodiments, such cleaning system may be obtained by utilizing a cleaning system that can be arranged to clean by suction a screen filter configuration of the filter in a generally pressure-wise balanced. The screen filter configuration may include one or more, for example two, screen filter members.

In certain embodiments the filter may be arranged in a generally symmetrical arrangement to facilitate such a pressure-wise balanced cleaning action, and in other embodiments the filter may not necessarily be arranged in such a generally symmetrical arrangement.

An example of a generally symmetrical arranged filter may be embodied by the filter comprising two screen filter members, and the cleaning system possibly including two cleaning mechanism each configured to clean a respective one of the filter members of the filter arrangement.

Both cleaning mechanisms may be connected by an axially extending continuous and possibly integral shaft-like core of the cleaning system, that extends out of a flush chamber of the filter on both sides of the flush chamber, in a way that the total axial forces on the shaft ends are generally equal and in generally opposing axial directions, so the total axial forces on the shaft equals zero or is very small.

This can be achieved by using similar shaft cross-sections on both sides of the suction mechanism at similar pressure, or by using different shaft cross-sections at different pressures, respectively, while maintaining the same ratio between the shaft cross-section and the surrounding pressure.

Such shaft may accordingly be a shaft member of the cleaning system, about which one or more of the cleaning mechanisms may be arranged to rotate while also advancing in an axial direction to cover and clean substantially the entire inner surface of the screen filters in both filter members.

In at least certain embodiments, both filter members may be in communication with a common flush chamber, located at a center of the filter arrangement's cleaning system, in between the filter members. The core preferably passes through the common flush chamber, where substantially low pressure and/or close to ambient pressure exists.

The core in case of a generally symmetrical arranged filter, may be arranged to extend away from its central region within the flush chamber and through the filter members, reaching its opposing axial ends that are arranged to be exposed to similar pressure conditions.

For example, the opposing axial ends of the core may be located each within an end region of their respective filter member exposed to substantially similar pressure conditions residing in the symmetrically positioned filter members.

In another example, the ends of the core may be arranged to extend out of the filter members to locations beyond the external body of the filter arrangement possibly to the ambient environment where again substantially similar atmospheric pressures may reside.

Thus, the aforementioned balancing of the cleaning system may be observed in certain cases, by substantial lack of exposure of the core to axial forces at its central region while exhibiting substantially similar exposure to pressure at both axial ends that act to substantially counter each other (in case of exposure to similar pressures at both ends) and by that balance out forces (possibly axial forces) applied upon the core and consequently upon the cleaning mechanisms during a cleaning operation.

In at least certain embodiments, the flush chamber of the cleaning system may be at least partially separated from incoming water (and consequently pressure), at a respective inlet and outlet of filter arrangement.

The flush chamber may be arranged to include an outlet port, including an internal or external flush valve. Such flush valve may be controlled in various manners (e.g. manually, remotely, automatically, by sensing e.g. pressure, time, flow etc.) to open or close and by that start or cease a cleaning action of the cleaning system.

In at least certain embodiments, opening the flush valve may expose the interior of the flush chamber to low pressure, e.g. substantially ambient pressure, thus urging liquid to flow from the pressurized environment within the filter arrangement via the suction nozzles of the cleaning mechanism, and by that cleaning of the screens of the screen filters. The liquid sucked in by the suction nozzles may be arranged to flow through an internal passage in the shaft-like core to the flush chamber to be emitted from there to outside of the screen filter, possibly to the ambient environment.

Such cleaning operation by the cleaning system may be accompanied by movement of the cleaning mechanism(s) along the screen face. Such movements may be performed according to various embodiments of the invention in several ways.

In certain embodiments, the core of the cleaning system may comprise a threaded portion, in certain cases a bi-directional screw/threaded portion for urging axial movement of the core and cleaning mechanism(s) in opposing (possibly reciprocating) axial directions while turning in a similar rotational direction.

While typical screws require change in rotational direction to urge movements in opposing axial directions, such bi-directional screw/thread (possibly also referred to as a self-reversing screw) can utilize one direction of rotation to achieve reciprocated bi-directional lateral movement.

This can be obtained using a follower blade nut-type configuration, that initially matches a first helical thread formed in the screw to urge axial movement in a first direction, wherein said blade can be made to pivot in order to match an opposing helical thread formed in the screw in order to urge advancement in an opposing axial direction.

It is noted that in certain embodiments of the present invention, other types of threaded/screw-arrangements may also be possible for assisting in such axial movements—while in certain embodiments, other measures may be employed urging rotational/axial movements of the cleaning mechanisms.

In certain embodiments, a turbine member may be fitted at a central region of the shaft-like core so that liquid flowing through the passage within the core towards the flush chamber from the suction nozzles may be arranged to flow via the turbine to be discharged into the flush chamber.

In certain cases, the turbine may be formed with curved channels that urge rotation of the turbine and consequently the core together therewith as liquid flows therethrough. Such rotation may urge axial and/or rotational movements of the core and cleaning mechanisms coupled to the core.

Possibly, suctions nozzles may be arranged to extend generally radially from the shaft-like core to be suitably positioned for scanning the screen face.

Accordingly, in certain embodiments a bi-directional screw may be located at an end of the core, so that when the core rotates the bi-directional screw rotates together therewith, causing the cleaning mechanism to axially move according to the bi-directional screw's pitch that is engaged with its associated blade nut-type configuration.

Once the blade reaches the end of the pitch along which it advances, pivoting of the blade urges it to now advance along the other thread within the screw that has an opposing pitch. This in turn urges axial movement of the core that is coupled to the bi-directional screw and consequently the cleaning mechanism that is fitted thereto—in an opposite direction, while the screw continues its rotation in the same direction. Thus, in such embodiment, back and forth scanning and cleaning of the filter's screen(s) can be performed, while the flush valve is open.

In certain embodiments, instead of a screw, two pistons may be provided, one at each side of the core. A control mechanism, possibly external to the filter, may be arranged to operate each piston alternately, thus moving the cleaning mechanism(s) axially back and forth, while the rotational movement may be possibly achieved by other independent source (hydraulic, electric or other).

In certain embodiments, a filter arrangement embodiment may not necessarily include an internal turbine, while possibly in such configuration the core may include a perforated section at its central region, which is located within the flush chamber.

In certain embodiments, movement of the shaft-like core and cleaning mechanisms coupled thereto, may be performed by arranging at least one of the ends of the core to project out of the external body of the filter arrangement to be coupled to an external device, e.g. motor, that is arranged to rotate the core and by that the cleaning mechanisms attached thereto, in order to ignite axial movement according, e.g., to a screw that is coupled to the core.

In certain embodiments, the screw coupled or formed in the core, may be a uni-directional screw and a motor externally coupled to the core may be urged to rotate back and forth in opposing rotational directions in order to advance the cleaning mechanisms in opposing axial/rotational directions, e.g. via an external controller.

A driving member of a uni-directional screw type, according to various embodiments of the present invention, may be defined as requiring change in rotational direction in order to urge movements in opposing axial directions.

In certain embodiments, the cleaning mechanism may be arranged to be substantially fully within the external body of the filter arrangement and may be suited with a magnetic member within or coupled to the shaft-like core. An external motor may be connected to the magnetic member for rotating the suction nozzles without physical contact between the two. In certain embodiments, the suction nozzles may comprise a magnetic member, and an external motor may be urged to rotate by magnetic force the suction nozzles without physical contact between the two.

In at least certain embodiments there may be provided a filter arrangement that includes a mechanism (possibly automatic) that may utilize hydraulic force for generating rotation of its shaft-like core. Possibly, the shaft rotation may be automatically shifted at the end of stroke position.

The mechanism may be based on a combined, bi-directional turbine structure, that includes two opposite turbines connected, each including opposing internal curved channels. An inlet to each turbine may be separated between the two turbines, so the water flow can be directed to one turbine, while the other is blocked.

Water flowing through a first one of the turbines may urge the turbine to rotate in a first rotational direction (e.g. clockwise), and directing water to flow through a second one of the turbines urges rotation of such turbine in an opposing rotational direction (e.g. counter clock-wise).

Such bi-directional turbine may be positioned upon a core of the filter's suction shaft arrangement to urge rotational movements of the shaft. Such movements of the turbine relative to the shaft may be defined to occur for a certain distance or degrees, by possibly limiting same by a grooved slot and a stop pin (or the like), that allows precise movements within those limits

In certain embodiments, such bi-directional turbine may include two separate and opposite flow channels. Each entry port to a given one of the flow channels may be aligned with a corresponding port at the suction shaft tube. The bi-directional turbine can slide along the main shaft, while blocking the inlet ports of one side of the turbine and allowing water passage through the ports of the opposite channels at the turbine.

This movement can be linear (along the shaft axis) or rotational (around the shaft axis) and may be limited by use of a slot and centering pin positioned inside the slot, to limit the sliding movement of the turbine along the shaft.

As the turbine reaches the side of the flush chamber, it may be forced to move along the suction shaft (due to the contact with the flush chamber walls or other limiting component). Since the shaft may be free to move (as it is not restricted by the flush chamber walls), and has inertia, even though the turbine is forced to stop, the shaft may keep on moving respective to the turbine, thus enabling blocking of one set of flow channels, and opening of the other set as explained above.

This movement can be stopped once the centering pin has reached the end of the slot. At that point, as the rotation direction of the turbine may have been changed due to the switch of the active flow channels, the turbine and the suction shaft extract from the suction chamber wall and advance to the other side of the suction chamber, and vice versa. In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1A schematically shows an isometric view of an embodiment of a generally symmetrical filter arrangement in accordance with the present invention.

FIG. 1B shows an assembled view of the cleaning system of the filter arrangement of FIG. 1A.

FIG. 1C shows an exploded view of the cleaning system seen in FIG. 1B.

FIG. 1D shows a cutaway view of the filter arrangement of FIG. 1A, along with enlarged portions of the cutaway view, to illustrate water flow through the device;

FIG. 1E schematically shows top and two cross-sectional side views of a first embodiment of a generally non-symmetrical filter arrangement in accordance with the present invention; FIG. 1EC is the top view, FIG. 1EA is a cross-sectional side view taken along lines A-A of FIG. 1EC while FIG. 1EB is a cross-sectional side view taken along lines B-B of FIG. 1EC;

FIG. 1F schematically shows top and two cross-sectional side views of a second embodiment of a generally non-symmetrical filter arrangement in accordance with the present invention; FIG. 1FC is the top view, FIG. 1FA is a cross-sectional side view taken along lines A-A of FIG. 1FC while FIG. 1FB is a cross-sectional side view taken along lines B-B of FIG. 1FC;

FIG. 2 schematically shows a possible self-reversing screw and blade nut-type configuration that may be used in embodiments of a filter arrangements of the present invention;

FIGS. 3 to 6 schematically show various turbines that may be used in filter arrangement embodiments:

FIG. 3 shows a first turbine embodiment that may be used in filter arrangement embodiments, in which FIG. 3A is an isometric view of the turbine, FIG. 3B is a cutaway isometric view of the turbine and FIG. 3C is a plan view of the turbine;

FIG. 4A shows a second turbine embodiment that includes first and second disc members which create torque in opposite rotational directions, in which FIG. 4AA shows a side view of the turbine assembly, FIG. 4AB shows the first turbine disc, FIG. 4AC shows the second turbine disc and FIG. 4AD shows a schematic of the environment of the second turbine embodiment;

FIG. 4B shows a reversing mechanism for altering rotational direction when a disc member engages a barrier in the turbine of FIG. 4A;

FIG. 4C shows the operational stages of the reversing mechanism in the turbine of FIG. 4B, in which FIG. 4CA shows a first stage, FIG. 4CB shows a second stage, FIG. 4CC shows a third stage, and FIG. 4CD shows a fourth (final) stage;

FIG. 5 shows a third turbine embodiment having a disc with two sets of channels, each for creating torque in a different rotational direction, in which FIG. 5A shows a side view of the turbine assembly, FIG. 5B shows a core having a bulge for use in the third turbine embodiment, FIG. 5C shows a disc having a groove for engaging the bulge and FIG. 5D shows the two sets of channels on the disc;

FIG. 6A shows a fourth turbine embodiment in which the nozzles are shaped to create torque;

FIG. 6B shows another turbine embodiment in which the turbine is positioned within an internal passage of the core, along an axial extent thereof;

FIG. 6C shows yet another turbine embodiment in which the turbine which is positioned within an internal passage of the core, near one end thereof;

FIG. 7 shows a spiral rail arrangement for urging combined rotational and axial movement of nozzles, for use in various filter arrangements embodiments of the present invention; and

FIG. 8 shows a modified spiral rail arrangement having spacer wheels to prevent nozzles from contacting the filter screen.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

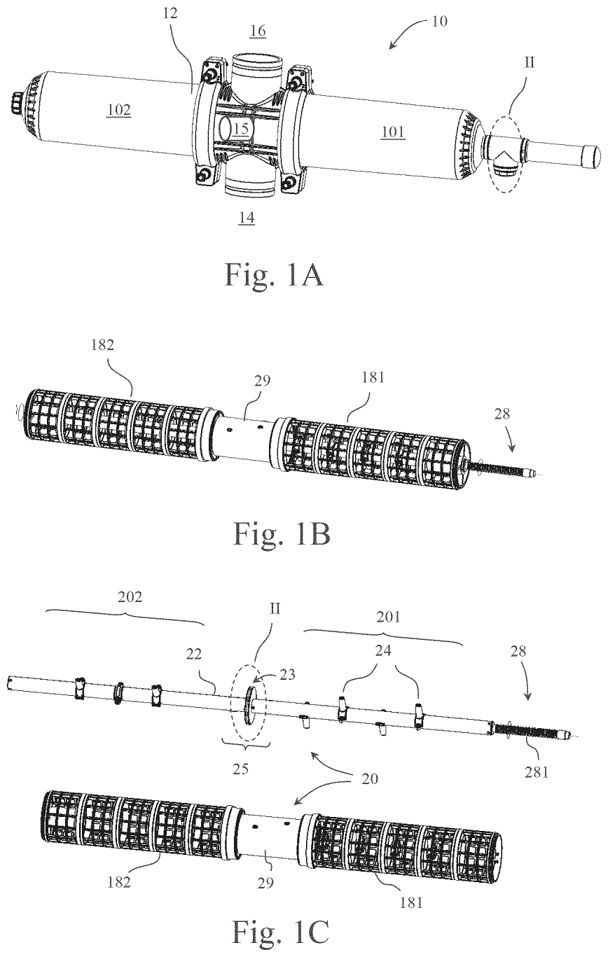

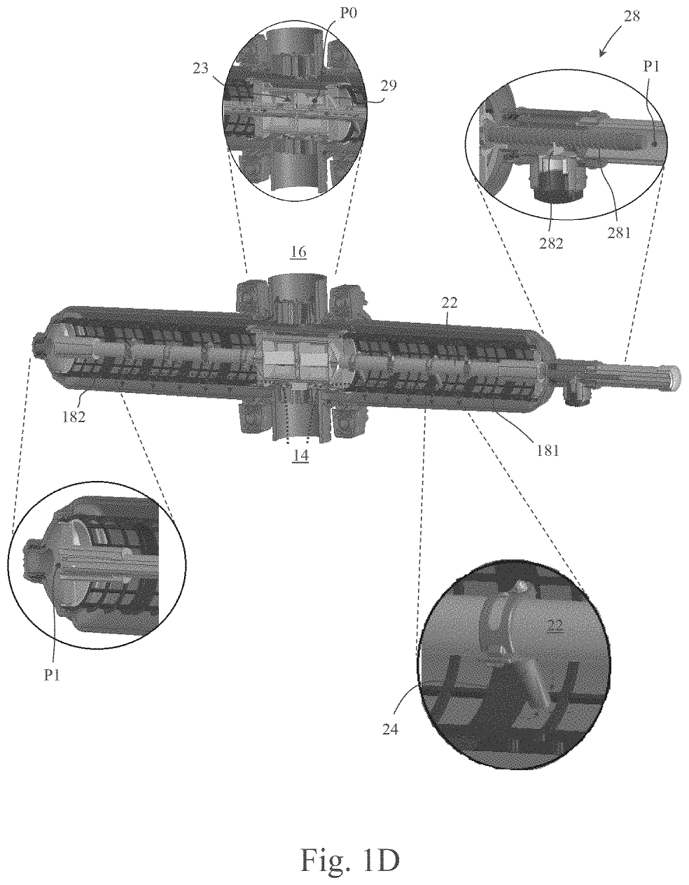

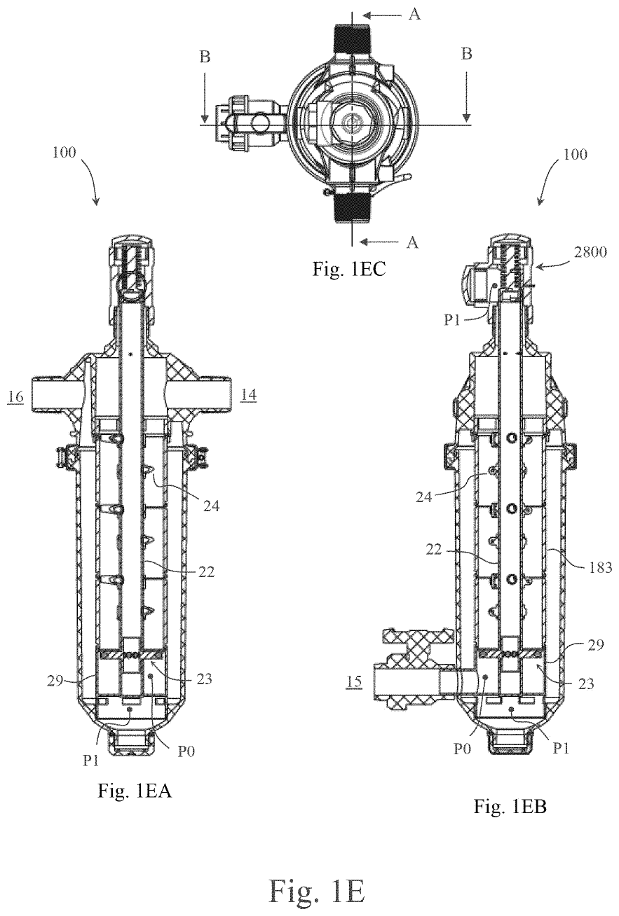

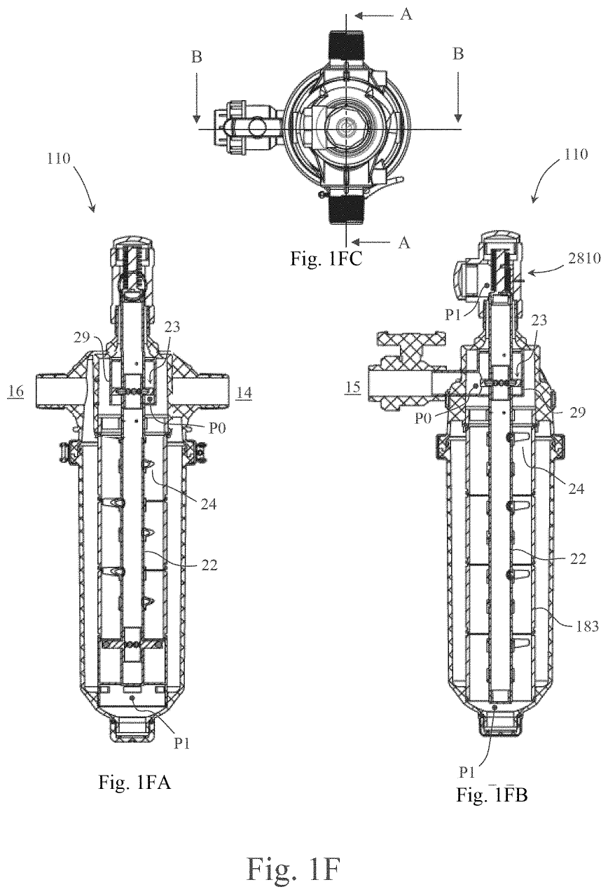

Attention is first drawn to FIGS. 1A to 1D illustrating at least some possible embodiments of a filter arrangement 10 of the present invention. In FIG. 1A filter arrangement 10 can be seen including an external body 12 enclosing a generally symmetrical balanced filter configuration, here embodied by a double filter configuration having two opposing filtration parts 101, 102 (first filter part 101 and second filter part 102). External body may be formed in some examples as two cover members.

Filter arrangement 10 has an inlet 14 through which incoming liquid (e.g. water) to be cleaned is received, an outlet 16 through which the relative cleaner liquid can exit after filtering out dirt/particles, and a flush valve 15 for flushing out liquid during a back- flushing cleaning action of the filter.

Attention is additionally drawn to FIGS. 1B and 1C illustrating respective assembled and exploded views of interiors of the filter parts 101, 102 showing screen filters 181, 182 (first screen filter 181 and second screen filter 182) and an embodiment of a cleaning system 20 of the present invention.

Cleaning system 20 in the shown example includes two opposing cleaning mechanism 201, 202 each configured to clean a respective one of the filter members 181, 182. The cleaning system 20 has a shaft-like hollow core 22 with suction nozzles 24 located there-along that are arranged to be in communication with an internal passage (see 221 visible in FIG. 3) of the shaft-like hollow core 22.

Cleaning system 20 includes in addition a turbine arrangement 23 located at a central region 25 of the core. Each of the opposing cleaning mechanisms 201, 202 is defined as including a respective opposing section of the shaft-like core 22 extending away from the central region 25 and the suction nozzles 24 associated with such section.

Cleaning mechanism 20 in addition includes a driving member 28 in this example embodied as a self-reversing screw 281 and blade nut-type configuration 282 (see also FIG. 1D). Also, cleaning mechanism 20 in seen including a flush chamber 29 located in-between and in connection with the screen filters 181, 182—with flush valve 15 being configured to communicate liquid out of the flush chamber, possibly to the ambient environment.

In an assembled state of the cleaning mechanism 20 and screen filters 181, 182 (see FIGS. 1B and 1D); the core's central region 25 and its turbine arrangement 23 are located within the flush chamber 29, with each cleaning mechanism 201, 202 extending through a respective one of the screen filters 181, 182.

During a filtering process (see FIG. 1D), liquid marked by the dotted lines enters filter arrangement 10 via inlet 14 to pass along an outer side of flush chamber 29 and flow along an interior face of the screen filters 181, 182. The liquid then passes in a general radial direction through the screen filters to their exteriors while being cleaned from dirt and leaving a so called “filtration cake” on the interior sides of the screen filters. The cleaned liquid then flows out of the filter arrangement 10 via outlet 16 as indicated by the dotted-dashed arrow lines.

Flush valve 15 may be controlled in various manners (e.g. manually, remotely, automatically, by sensing e.g. pressure, [symbol] ow, etc.) to open or close and by that start or cease a cleaning action of the cleaning system.

In at least certain embodiments, opening flush valve 15 may expose the interior of the flush chamber 29 to low pressure, e.g. substantially ambient pressure, thus urging liquid to be sucked out of the pressurized environment within the filter arrangement via the suction nozzles 24. The dashed arrows in the enlarged section at the lower right-hand side of FIG. 1D illustrate this suction process applied to the inner side of the screen filters by the suction nozzles.

This in turn results in cleaning of the inner sides of the screen filters from the so-called “filtration cake” that is sucked away from the screen filters 181, 182. The liquid sucked in by the suction nozzles flows through the core's internal passage towards the flush chamber 15. The dashed arrows in enlarged section at the upper left-hand side of FIG. 1D illustrate such liquid sucked away from both screen filters 181, 182 arriving at the core's central region within the flush chamber.

Such cleaning operation by the cleaning system may be accompanied by movement of the cleaning mechanisms 201, 202 along the screen filters 181, 182. Such movements may be performed according to various embodiments of the invention by providing the cleaning systems with various types of driving members.

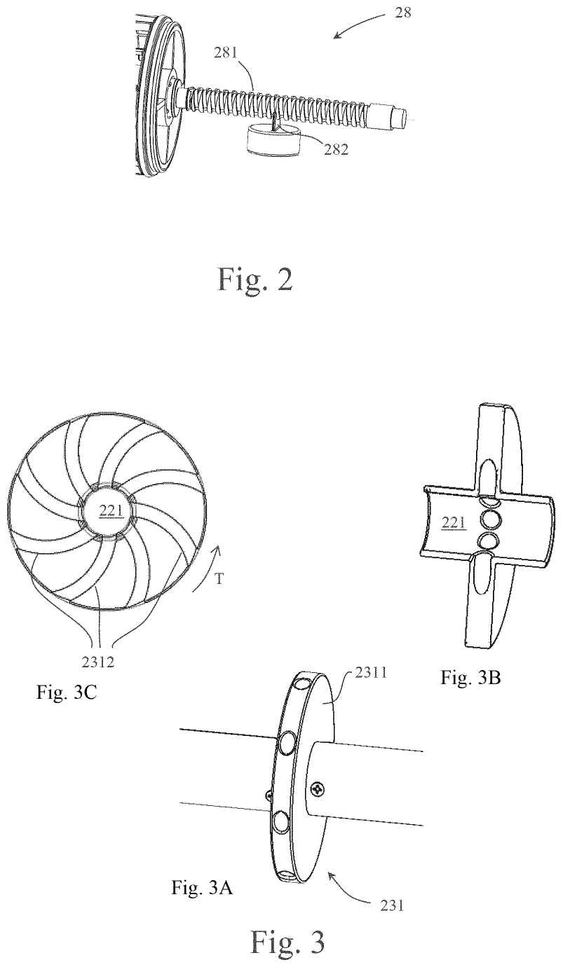

In the example shown in FIG. 1D, the driving member 28 (shown also in FIG. 2) is embodied as a self-reversing screw 281 and blade nut-type configuration 282. The blade nut-type configuration 282 may be arranged to initially match a first helical thread within screw 281 to urge axial movement in a first direction. Upon completing a scan of the filter screens along the first direction, the blade 282 can be made to pivot in order to match an opposing helical thread within screw 281 in order to urge advancement in an opposing axial direction.

In an aspect of the present invention, filter arrangements 10 may be provided with a so-called balanced cleaning system, by harnessing a possible generally symmetrical filter configuration, for example a double generally symmetrical filter configuration as here shown, for balancing out axial forces imposed upon the system during a cleaning operation.

The balancing of the cleaning system may be observed in certain cases, by exposure of the core to a pressure PO at its central region that may be substantially “zero”, while being exposed to substantially similar pressures P1 at both axial ends that act to substantially counter each other and by that, balance out forces (possibly axial forces) applied upon the core and consequently upon the cleaning mechanisms during a cleaning operation.

In certain cases (not shown), the ends of the cores may extend to outside of the body of the filter arrangement, and by that may be exposed to similar pressure P1 at ambient environment—again serving for balancing out forces from being applied upon the cleaning system during its operation.

Attention is drawn to FIGS. 1E and 1F illustrating embodiments of non-symmetrical filter arrangement 100, 110 exemplifying also a generally balanced filter configuration.

Both filter arrangements include a shaft-like hollow core 22 with suction nozzles 24 located there-along that are adapted to clean respective screen filters 183 of the filters.

The balancing of the cleaning system in these embodiments may be observed, by exposure of the core to substantially similar pressures P1 at both its axial ends, which act to substantially counter each other and by that balance out forces (possibly axial forces) applied upon the core and consequently upon the cleaning mechanisms during a cleaning operation.

Such exposure of the core to substantially similar pressures at both axial ends may be accomplished in one example by maintaining both axial ends of the core outside of e.g. the flush chamber of the filter where a pressure PO is lower, possibly substantially equal to that in the ambient environment.

Filter arrangement 100 (see FIG. 1E) exemplifies an embodiment where the inlet 14 and outlet 16 of the filter both are adjacent one axial end (first axial end) of the filter (here the upper end), while the filter's turbine arrangement 23, flush chamber 29 and flush valve 15 are located adjacent the opposing axial end (second axial end) of the filter. Filter arrangement 110 (see FIG. 1F) exemplifies an embodiment where the inlet 14, outlet 16, turbine arrangement 23, flush chamber 29 and flush valve 15 are all located adjacent one of the axial ends of the filter (here the upper end).

Attention is drawn to FIG. 3 illustrating an embodiment of a turbine arrangement 231. Turbine 231 includes a disc member 2311 and a plurality of channels 2312 that extend from the core's interior passage 221 to the outer periphery of the disc member. In this example, all the channels are similarly curved, and thus liquid flowing through turbine 231 is arranged to cause torque T in one direction about the core's axis urging the core to rotate in said direction about its axis.

Combining turbine 231 with an embodiment of a driving member 28 that includes a self-reversing screw 281 and blade nut-type configuration 282, may provide for back and forth movement of the cleaning mechanisms along the screen filters, with a turbine (such as 231) that can urge rotation only in one rotational direction about the core's axis. By shutting closed the flush valve 15, the cleaning process of the screen filters can be stopped.

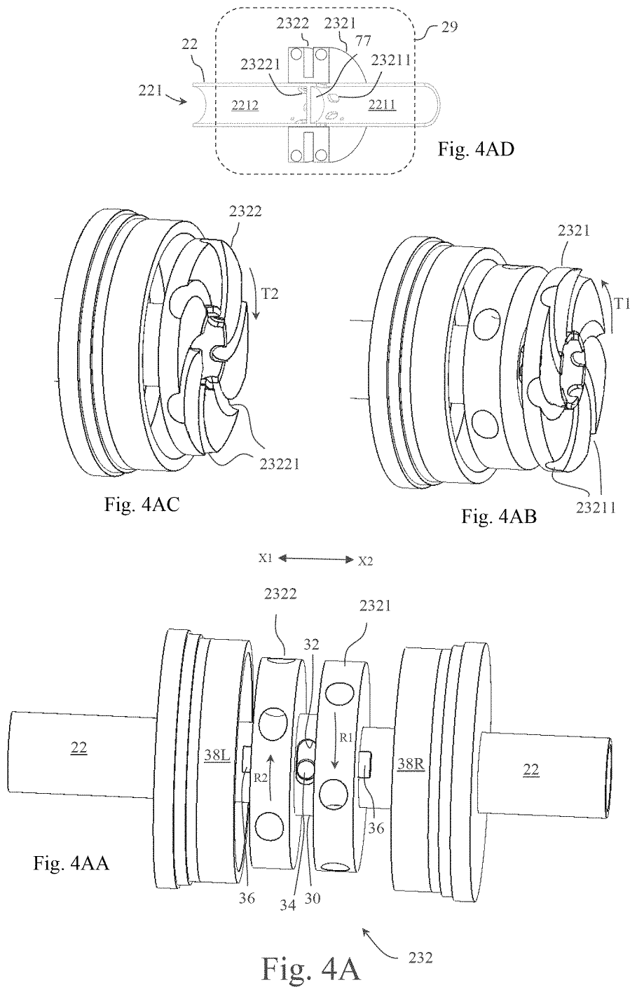

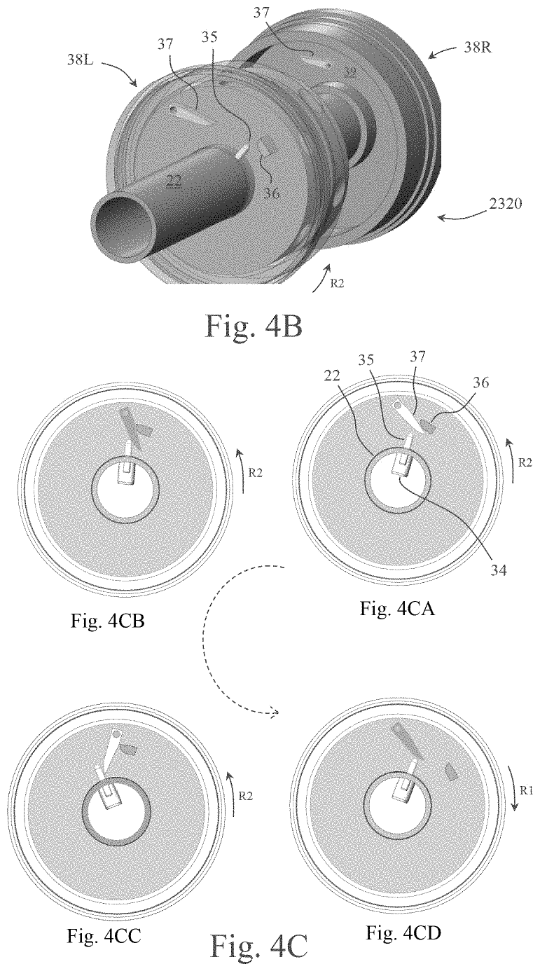

Attention is drawn to FIG. 4A illustrating an embodiment of a turbine arrangement 232 that includes first and second disc members 2321, 2322. Each one of the disc members is formed, respectively, with a plurality of channels 23211, 23221 that extend from the core's interior passage to the outer periphery of each disc member, as seen in FIGS. 4AB and 4AC.

In this embodiment, the channels of the first disc member are arranged to form torque T1 that urges rotation of the core in a first rotational direction (R1) about its axis, while the channels of the second disc member are arranged to form torque T2 that urges rotation of the core in a second rotational direction (R2) about its axis that is opposite the first rotational direction.

Turbine 232 may be formed with a bridge 30 that connects the first and second disc members 2321, 2322 to each other. Bridge 30 can be formed with a slit 32 and the core can be formed with a pin 34 that is located within the slit, thus allowing turbine 232 to shift about the core between first and second extremities where the pin engages opposing ends of the slit.

At each one of the extremities, turbine 232 is arranged to expose channels (23211, 23221) within only a given one of its disc members (2321, 2322; respectively) to liquid flowing within the core's internal passage 221, thus urging rotation of the core according to the respective torque formed as liquid flows through the channels of the given disc member. In FIG. 4AA at the lower side of FIG. 4A, turbine 232 is shown at one of the extremities where the second disc member 2322 is in communication with the liquid flowing within the core. Therefore, the arrangement shown in this lower view of FIG. 4AA depicts rotation of the turbine and the core in direction R2.

A driving member (in this example of a uni-directional type, that requires change in rotational direction of a threaded portion to urge axial movements in opposing directions)—that can be fitted to the core—may dictate that rotation R2 of turbine 232 urges axial movement of the core and the cleaning mechanism(s) fitted thereto in direction X2 along the core's axis. The turbine and core may thus progress in direction X2 until a stop member 36 (possibly in the form of a notch or tooth) that is fixed to the turbine engages a right-hand side barrier 38R (or a structure fitted thereupon) of the flush chamber.

Implementing turbine 232, e.g., in a generally symmetrical filter configuration, such as that shown in FIGS. 1A to 1D, may result in movements in cleaning mechanisms 201, 202 being assisted by a driving mechanism (as mentioned above). Implementing turbine 232 e.g. in a generally non-symmetrical filter configuration, such as that shown in FIGS. 1E and 1F, may result in movements in this filter's cleaning mechanism being assisted by a uni-directional driving mechanism such as 2800, 2810 shown in these figures.

Attention is drawn to FIG. 4AD in the upper most view in FIG. 4A to address a general aspect of the present invention, which relates to formation of two separate passageways within the internal passage of the shaft-like hollow core. In this shown example, internal passage 221 is divided into two such separate passageways 2211, 2212 by provision of a barrier 77 within the internal passage into—here in a location along a section of the shaft-like hollow core that is positioned generally within the flush chamber 29 of the filter.

Self-cleaning of screen filters, that are based on suction nozzles in order to evacuate debris (filtration cake) from the screen's inner side, rely on suction forces at the nozzle tips in order to facilitate efficient suction and cleaning of the filter face.

Higher suction force, or suction speed, usually translates into improved suction and superior cleaning capabilities. Suction force, or suction speed at the nozzles may be a function of the nozzles area (sum of nozzles) and the flush water flow rate (e.g., ‘nozzle suction velocity’) may be generally equal to ‘nozzle area’/‘suction water flow rate’.

Large screen areas typically require more suction nozzles (since each nozzle can cover only a limited area of the screen), and thus the total nozzle area increases. This in turn, may require higher flush flow rates in order to maintain the same suction speed at the nozzles.

Increasing the flush flow rate in at least certain cases may be less recommended due to several reasons: It may require a larger and more expensive pump to support the system, higher energy (pump) usage during flush, the amount of water that is flushed out of the system increases, larger pressure losses within the flush system, and possibly large and significant flow interference at the irrigation flow rate during flush.

An example relevant, inter alia, to the last-mentioned reason may be the following. If irrigation requires e.g. 100 m\hat{ }3/Hour, and flush requires 30 m\hat{ }3/Hour—that means that during a cleaning action about 30% of the flow may be diverted to be flushed out of the filter arrangement. If on the other hand the flush flow rate were to be less, e.g., about half of that in the discussed example, i.e. about 15 m\hat{ }3/Hour, then only about 15% of the water may end up being diverted to be flushed out of the total flow.

Thus, in at least certain embodiments where a filter arrangement includes more than one filtration element (e.g., screen), selective flushing of each filtration element may be advantageous in order to avoid the above-mentioned disadvantages that may occur if the flow of water being flushed were to be larger. The filtration arrangement in FIGS. 1A-1D, which includes two screen filters 181, 182 is an example of a filtration arrangement where such formation of two separate passageways within the internal passage of the shaft-like hollow core may be suitable.

In embodiments discussed herein where filtration arrangements include a single, shared flushing mechanism, an arrangement that comprises presence of a barrier dividing the internal passage through the shaft-like hollow core into separate passage members 2211, 2212 may be suited to address the above.

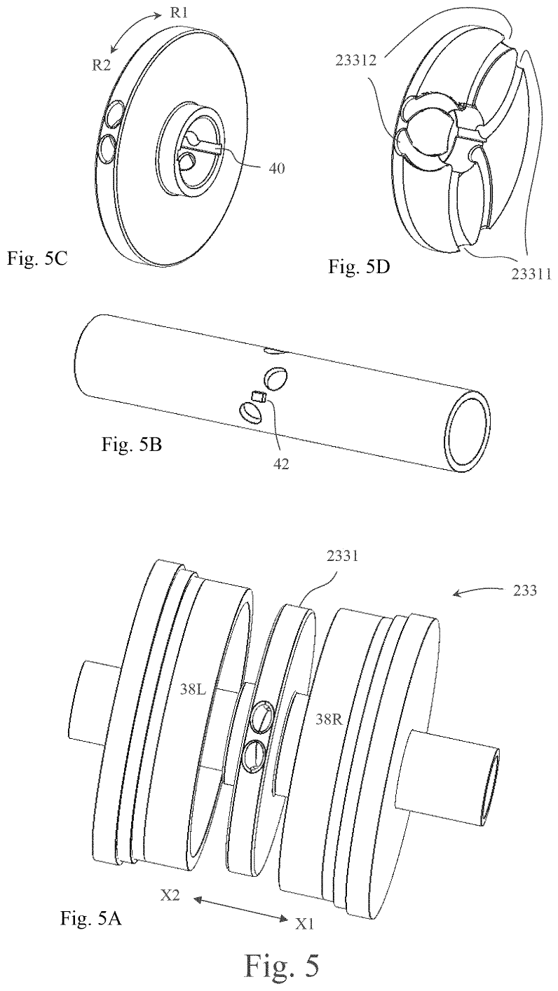

Although provision of two separate passageways has been exemplified in the figures with respect to turbine arrangement 232, it is noted that formation of such two separate passageways may be envisioned in other filtration arrangements and/or in conjunction with other turbine arrangements, such as turbine 23 seen in FIG. 1B, turbine 231 seen in FIG. 3, turbine 2320 seen in FIG. 4B, turbine 233 seen in FIG. 5 (or the like).

Engagement between stop member 36 and (in the discussed example) the right-hand side barrier 38R (or a structure fitted thereupon), may urge turbine 232 to start rotating in an opposing direction. This may occur by momentarily stopping the rotation of the turbine in direction R2, while the core continues due to momentum to rotate in direction R2 thus shifting pin 34 to engage the opposing extremity of slit 32.

At this opposing extremity, turbine 232 is arranged to bring the channels formed within the first disc member 2321 into communication with liquid flowing through the core (while blocking the flow channels set at disc 2322)—thus urging rotation of the turbine 232 in direction R1 about the cores' axis with combined axial movement in direction X1.

This new combined movement (R1, X1) of the core and the cleaning mechanism(s) fitted thereto may urge a cleaning scanning action of the screen filter(s) in an opposing direction. This may continue until a stop fitted to an opposing side of the turbine engages a left-hand side barrier 38L of the flush chamber—thus potentially igniting a repeated movement according to R2, and X2. By shutting the flush valve 15, the cleaning process of the screen filters can be stopped.

Attention is drawn to FIGS. 4B and 4C illustrating a turbine embodiment 2320 generally similar to 232, while mainly differing from it in its mechanism for altering rotational direction when engaging a barrier of its flush chamber. In this embodiment, each barrier (38R, 38L) of the flush chamber may be fitted at its respective inner side 39 facing into the flush chamber with a lever member 37 which is pivoted to the inner side.

With attention specifically drawn to FIG. 4C, the operation of the proposed mechanism of this embodiment will be described, while starting at the upper right-hand side image of this figure (FIG. 4CA)—and then proceeding to subsequent images in this figure according to the ‘dashed’ arrow.

The upper right-hand side image of FIG. 4CA illustrates an instance where a stop member 36 on a side of the turbine rotating in direction R2—reaches a position proximal to a barrier's inner side 39—and engages the lever member 37 on that inner side.

The biased lever member 37 being pivoted by stop member 36 can be seen in the subsequent image (upper left image of FIG. 4CB) engaging a raised bulge 35 that is fixed to the shaft-like hollow core 22. The turbine still rotating in direction R2 continues to apply rotation force via lever 37 against bulge 35 thus urging the core 22 to also rotate in direction R2.

This rotation of the core 22 in direction R2 proceeds until pin 34 that is also fixed to the core is shifted to a position where it engages an opposing extremity within slit 32 as seen in FIG. 4CC. In that position, the channels formed within the first disc member 2321 are brought into communication with liquid flowing through the core—thus urging rotation of the turbine 2320 in the opposing direction R1 about the core's axis (see lower right-hand side image of FIG. 4CD) with possible combined axial movement in direction X1 due to interaction with a driving member (such as a uni-directional type, that requires change in rotational direction of a threaded portion to urge axial movements in opposing directions).

Attention is drawn to FIG. 5 illustrating yet a further embodiment of a turbine arrangement 233. Turbine 233 includes a disc member 2331 formed in this example with two sets of channels 23311, 23312 that extend from the core's interior passage 221 to the outer periphery of the disc member, as seen in FIGS. 5A and 5D. Each one of the sets of channels 23311, 23312 is arranged to cause torque about the core's axis in a different rotational direction. As such they are configured for urging rotation about the core's axis in opposing rotational direction R1, R2.

An inner side of disc member 2331 is formed with a groove 40 that engages a bulge 42 formed on the core, as seen in FIGS. 5B and 5C. Thus, the engagement between the groove 40 and bulge 42 allows turbine 233 to slide upon the core between two extremities, wherein at each extremity one of the sets of channels 23311, 23312 is exposed to liquid flowing through the core.

When a respective one of the sets of channels is exposed to liquid arriving from the core, the turbine is urged to rotate about the core's axis according to the respective torque formed by said channels.

A driving member fitted to the core may dictate, e.g., that rotation R1 of turbine 233 urges axial movement of the core and the cleaning mechanism(s) fitted thereto in direction X1 along the cores' axis. The turbine and core may thus progress in direction X1 until engaging a right-hand side barrier 38R of the flush chamber.

This engagement may urge the turbine to slide towards its opposing extremity upon the core, as the core continues due to momentum to advance in direction X1. At this opposing extremity, turbine 233 is arranged to bring the other set of channels into communication with liquid flowing through the core—thus urging rotation of the turbine 233 in direction R2 about the cores' axis with combined axial movement in direction X2.

This new combined movement (R2, X2) of the core and the cleaning mechanisms fitted thereto may urge a cleaning action of the screen filters 181, 182 in an opposing direction. This may continue until the turbine engages a left-hand side barrier 38L of the flush chamber—thus potentially igniting a repeated movement according to R1, and X1. By shutting closed the flush valve 15, the cleaning process of the screen filters can be stopped.

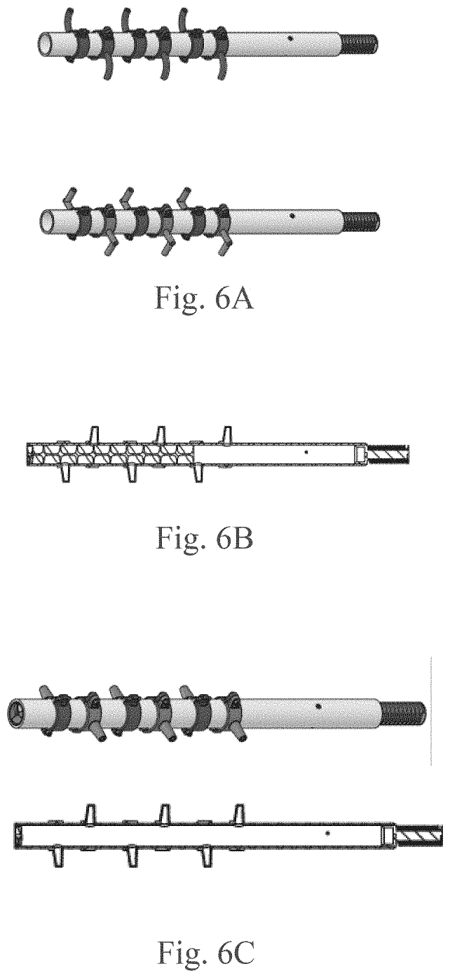

Attention is drawn to FIGS. 6A to 6C illustrating various other turbine embodiments that may be envisioned. In FIG. 6A, an embodiment is shown where the nozzles themselves may be used for urging torque and consequently rotational movement to the core. This may be accomplished by suitably curving the nozzles as then extend radially outwardly away from the core—so that they apply the required torque as liquid is sucked in by the nozzles during a cleaning operation.

In FIG. 6B, an embodiment is shown where an axially extending turbine may be chosen to be fitted within an axial portion of the internal passage of the core. Liquid urged to flow through the core during a cleaning operation and flowing passed a helical path defined by this turbine can be designed to apply suitable torque for urging rotation of the core.

In FIG. 6C, an embodiment is shown where a turbine segment may be chosen to be fitted adjacent an end of the internal passage of the core, here an end proximal to the flushing chamber of the filter. Liquid urged to flow through the core during a cleaning operation and flowing passed a helical path defined by this turbine segment can be designed to apply suitable torque for urging rotation of the core.

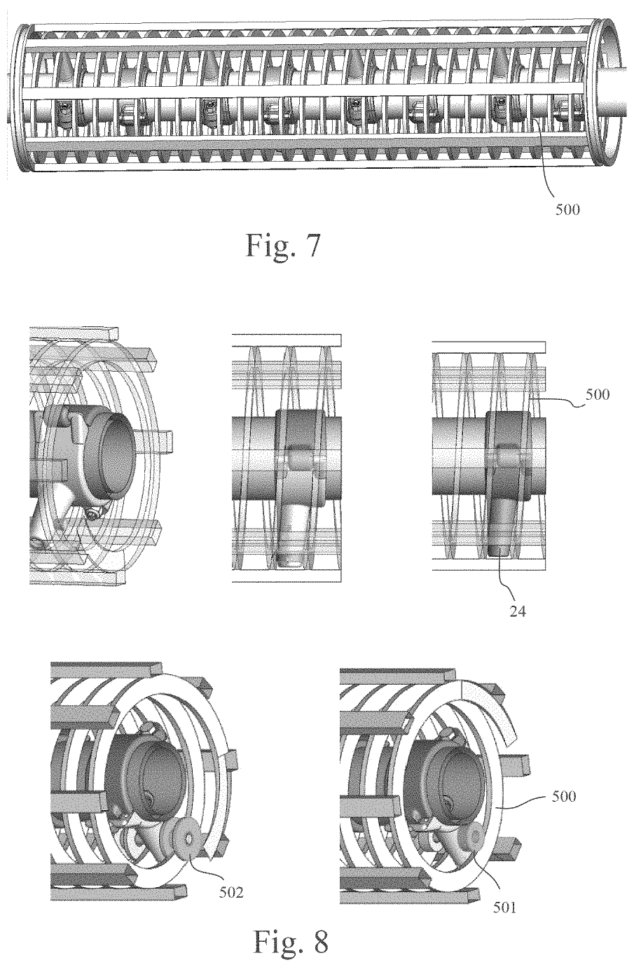

Attention is drawn to FIGS. 7 and 8 illustrating an aspect of the present invention directed at an alternative arrangement for urging combined rotational and axial movements of a cleaning mechanism along a screen filter. In an embodiment, a filter arrangement may be provided with a helical rail 500 formed upon an inner side of its screen filter.

A filter arrangement including any type of measure for urging rotation of its cleaning mechanism about the core's axis, may be guided to assume combined rotational and axial movement by helical rail 500. It is noted that such measures for urging rotation may include any one of the turbine examples discussed herein above, while also any other techniques such as an external motor coupled to the filter's core (and the like).

Suction nozzles 24 of a cleaning mechanism aimed at removing “filtration cake” from an inner side of the screen filter may be guided to move in an axial direction according to a pitch of the helix.

Such positioning of a tip of a suction nozzle closely between segments of the helical rail may assist in directing suction in a radial direction towards the inner side of the filter screen. Thus, the helix segments located on both sides of the suction tip may substantially block liquid from being sucked into such nozzles from lateral sides where the targeted “filtration cake” is substantially absent.

The lower views in FIG. 7 illustrate optional use of wheel members 501, 502 fitted to each nozzle and adapted to engage rail 500 during a cleaning action of the screen filter. Provision of such wheel members may be useful in ensuring that a tip of a nozzle is maintained at desired distance from the screen of the filter suitable for performing its intended cleaning action, while avoiding an intended contact with the screen of the filter that may damage the screen.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

What is claimed is:

1. A filter arrangement comprising a cleaning mechanism for cleaning at least one screen filter of the filter arrangement, the cleaning mechanism comprising:
a flush chamber;
a central hollow core that extends through the flush chamber; and
suction nozzles fitted to the core; wherein:
the core extends between opposing axial ends that are located outside of the flush chamber; and
the opposing axial ends are exposed to substantially similar pressures, at least during a cleaning operation of the cleaning mechanism.

2. The filter arrangement of claim 1, wherein liquid sucked in by the suction nozzles and flowing through the core is discharged out of the filter arrangement via the flush chamber during a cleaning operation.

3. The filter arrangement of claim 2, wherein:
a cleaning operation applied to a full axial extent of the at least one screen filter constitutes a cleaning cycle; and
the core is configured to axially move between two opposing axial positions, during a single cleaning cycle.

4. The filter arrangement of claim 1, further comprising:
at least one helical rail formed along an inner side of the screen filter, and wherein:
during a cleaning operation, at least some of the suction nozzles are prevented from engaging the inner side of the screen filter through engagement with the helical rail.

5. The filter arrangement of claim 1, further comprising a turbine through which liquid flows during a cleaning operation, and wherein the flow of liquid through the turbine is arranged to urge rotation of the core.

6. The filter arrangement of claim 5, further comprising a driving member for transforming rotation of the core also to axial movement of the core.

7. The filter arrangement of claim 6, wherein:
the core comprises opposing core segments extending away from the flush chamber in opposing axial directions, and
each core segment comprises suction nozzles.

8. The filter arrangement of claim 5, wherein the turbine is located within the flush chamber of the filter arrangement.

9. The filter arrangement of claim 5, wherein the turbine is disc shaped about an axial extension of the core.

10. The filter arrangement of claim 9, further comprising at least one channel set formed in the turbine for urging torque upon the turbine and the core, as liquid flows through the channel set.

11. The filter arrangement of claim 10, wherein:
the at least one channel set is two channel sets, and
torque formed by a first one of the channel sets when liquid flows therethrough is in an opposing direction to the torque formed by the other channel set when liquid flows therethrough.

12. The filter arrangement of claim 11, wherein during a cleaning operation, liquid is prevented from flowing simultaneously through the two channel sets.

13. The filter arrangement of claim 9, wherein:
the turbine comprises two disc members and two channels sets;
each channel set is formed within a respective one of the disc members;
a first one of the channel sets is arranged for urging torque about the core's axis in a first rotational direction as liquid flows therethrough; and
a second one of the channel sets is arranged for urging torque about the core's axis in an opposing, second rotational direction as liquid flows therethrough.

14. The filter arrangement of claim 13, wherein the two disc members are axially spaced apart from each other.

15. The filter arrangement of clam 5, wherein a passage through the central hollow core is divided into two separate passageways.

16. The filter arrangement of claim 15, wherein a barrier dividing the two separate passageways is located within a segment of the core that extends within the flush chamber.

17. The filter arrangement of claim 16, wherein the turbine is formed about the core at the same location where the barrier is located.

18. The filter arrangement of claim 17, comprising two screen filters, wherein the two separate passageways allow for cleaning only one of the two screen filters at a time.

19. The filter arrangement of claim 18, wherein during a cleaning operation the turbine is arranged to be urged to slide along the core in order to shift between the screen filters being cleaned.

20. The filter arrangement of claim 18, wherein during a cleaning operation, the turbine is arranged to be urged to rotate about the core in order to shift between the screen filters being cleaned.

21. The filter arrangement of claim 5, further comprising:
at least one helical rail formed along an inner side of the screen filter, and wherein:
during a cleaning operation, at least some of the suction nozzles are prevented from engaging the inner side of the screen filter through engagement with the at least one helical rail.

22. The filter arrangement of claim 5, further comprising:
at least one helical rail formed along an inner side of the screen filter, wherein:
the at least one helical rail is configured to act as a driving member for transforming rotation of the core also to axial movement of the core.

23. The filter arrangement of claim 5, wherein the turbine is located within the central hollow core.

24. The filter arrangement of claim 23, wherein the turbine is located at an end of the central hollow core, adjacent the flush chamber.

25. A filter arrangement having at least one screen filter with an inner side, and comprising:
a cleaning mechanism for cleaning the at least one screen filter, the cleaning mechanism comprising a central hollow core having an axis, and suction nozzles fitted to the core; and
at least one helical rail formed along the inner side of the screen filter, the at least one helical rail configured to guide a cleaning operation of the cleaning mechanism through engagement between at least some of the suction nozzles and the at least one helical rail.

26. The filter arrangement of claim 25, wherein during engagement between said at least some of the suction nozzles and the at least one helical rail, tips of the suction nozzles are prevented from engaging the inner side of the screen filter.

27. The filter arrangement of claim 25, wherein:
the core is arranged to rotate about its axis during a cleaning operation; and
guiding the cleaning operation comprises transforming rotation of the core also to axial movement of the core through the engagement between said at least some of the suction nozzles and the at least one helical rail.

28. The filter arrangement of claim 25, wherein:
segments of the at least one helical rail are placed on lateral sides of suction tips of said at least some of the suction nozzles, to thereby limit liquid from being sucked into such suction nozzles from such lateral sides, and direct suction into such suction nozzles in a radial direction from the inner side of the screen filter.
